(19) United States
(12) Patent Application Publication
(10) Pub. No.: US 2026/0074433 A1
(43) Pub. Date: Mar. 12, 2026

(54) FOLDABLE REFLECTOR PALLET AND METHOD OF DEPLOYING A FOLDABLE REFLECTOR PALLET

(71) Applicant: MacDonald, Dettwiler and Associates Corporation, Sainte-Anne-de-Bellevue (CA)

(72) Inventors: Marc-André GODIN, Laval (CA); Philippe GLOBENSKY, Montreal (CA)

(21) Appl. No.: 19/314,703

(22) Filed: Aug. 29, 2025

Related U.S. Application Data
(60) Provisional application No. 63/691,790, filed on Sep. 6, 2024.

(51) Int. Cl. H01Q 15/14

(52) U.S. Cl. CPC H01Q 15/147

(57) ABSTRACT

A foldable reflector pallet for reflecting a radio frequency (RF) signal, a method of deploying the foldable reflector pallet, and a method of stowing the foldable reflector pallet are provided. The foldable reflector pallet has a smaller footprint when stowed than when deployed and includes first and second reflectors each including a respective reflective surface, for reflecting the RF signal in a deployed configuration, disposed opposite a respective backing, the first and second reflectors mutually attached by a permanent connector, and at least one temporary connector mounted to a stowing surface for detachably connecting to the first and/or second reflector in a stowed configuration. The first and second reflectors are configured to selectively move between the deployed configuration, in which the first and second reflectors are not folded about the permanent connector, and the stowed configuration, in which the first and second reflectors are folded about the permanent connector.

### TECHNICAL FIELD

The following relates generally to antenna reflectors, and more particularly to foldable reflector pallets for antennas.

### Introduction

In satellite development and use, minimizing and efficiently using volume on satellites or launch vehicles is of critical importance. Larger reflectors are more directive and thus more desirable for high-capacity antennas, but such larger reflectors may occupy a commensurately larger volume on satellites and launch vehicles.

Where multiple reflector apertures are desired, accommodating such multiple reflector apertures in a small volume may disadvantageously lead to complex stowing and deployment approaches, where multiple complex deployable arms are desired. Given a general desire in the field to maximize the diameter of the reflector, usage of such complex deployment arms disadvantageously cannibalizes available space in a limited launcher volume. Accordingly, there is a need for an improved system and method for deploying multiple reflector apertures, each as large as possible, on smaller spacecraft that overcomes at least some of the disadvantages of existing systems and methods.

### SUMMARY

A foldable reflector pallet for reflecting a radio frequency (RF) signal is provided. The foldable reflector pallet has a smaller footprint when stowed than when deployed. The foldable reflector pallet includes: first and second reflectors each comprising a respective reflective surface, for reflecting the RF signal in a deployed configuration, the first and second reflectors mutually attached by a permanent connector; and at least one temporary connector mounted to a stowing surface for detachably connecting to the first and/or second reflector in a stowed configuration. The first and second reflectors are configured to selectively move between the deployed configuration, in which the first and second reflectors are not folded about the permanent connector, and the stowed configuration, in which the first and second reflectors are folded about the permanent connector.

The foldable reflector pallet may further include a boom or gimbal for moving the first and second reflectors away from the stowing surface in the deployed configuration.

The boom or gimbal may include a plurality of segments.

The at least one temporary connector may include three temporary connectors.

The stowing surface may be a spacecraft or a portion of a spacecraft.

The boom or gimbal for moving the first and second reflectors away from the stowing surface may be the only boom or gimbal respectively provided in the foldable reflector pallet.

Each reflector may be disposed opposite a respective backing.

A method of deploying a foldable reflector pallet for reflecting a radiofrequency (RF) signal is also provided. The foldable reflector pallet has a smaller footprint when stowed than when deployed. The method includes: providing the foldable reflector pallet in a stowed configuration adjacent a stowing surface; actuating the foldable reflector pallet, from the stowed configuration, relative to the stowing surface; and unfolding the foldable reflector pallet.

Actuating the foldable reflector pallet relative to the stowing surface may include actuating the foldable reflector pallet via a boom or gimbal away from the stowing surface.

The boom or gimbal may include a plurality of segments.

The boom or gimbal may be the only boom or gimbal respectively provided in the foldable reflector pallet.

A method of stowing a foldable reflector pallet for reflecting a radiofrequency (RF) signal is provided. The foldable reflector pallet has a smaller footprint when stowed than when deployed. The method includes: providing the foldable reflector pallet in a deployed configuration relative to a stowing surface; folding the foldable reflector pallet; and actuating the foldable reflector pallet towards the stowing surface.

Actuating the foldable reflector pallet towards the stowing surface may include actuating the foldable reflector pallet via a boom or gimbal towards the stowing surface.

The boom or gimbal may include a plurality of segments.

The boom or gimbal may be the only boom or gimbal respectively provided in the foldable reflector pallet.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of a foldable reflector pallet in a folded or stowed configuration, according to an embodiment;

FIGS. 2A and 2B are perspective and bottom views, respectively, of the foldable reflector pallet of FIG. 1 in an unfolded or deployed configuration, according to an embodiment;

FIGS. 3A and 3B are perspective side and bottom views, respectively, of a foldable reflector pallet in an unfolded or deployed configuration, according to an embodiment;

FIG. 4, is a flow diagram of a method of deploying the foldable pallet reflector of FIG. 1 relative to a stowing surface, according to an embodiment; and

FIG. 5 is a flow diagram of a method of stowing the foldable reflector pallet of FIG. 1 relative to a stowing surface, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and / or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device / article (whether or not they cooperate) may be used in place of a single device / article. Similarly, where more than one device or article is described herein (whether or not they cooperate), it will be readily apparent that a single device / article may be used in place of the more than one device or article.

The following relates generally to antenna reflectors, and more particularly to foldable reflector pallets for antennas.

In particular, the present disclosure provides a foldable reflector pallet that may be stowed in a smaller fairing, due to compactness of the foldable reflector pallet, during launch or other times to minimize volume without transmitting difficulties or inefficiencies to the reflectors mounted or disposed on the foldable pallet. The foldable pallet includes at least two reflectors that fold together about a connector to be stowed on a platform or spacecraft to which they are mounted or otherwise disposed.

The present disclosure may advantageously provide a more efficient approach with respect to mass and cost, for example by avoiding duplicating equipment ordinarily required to deploy multiple reflectors. The present disclosure may further advantageously reduce the quantity of hold and release mechanisms (HRMs) by reducing moments at action points. The present disclosure may further advantageously eliminate inner shell cutouts for outer reflector HRMs, increasing radiofrequency performance. The present disclosure may further advantageously permit a stiffer configuration during launch. The present disclosure may further advantageously avoid multiple multi-hinge booms or multiple deployment mechanisms otherwise used to deploy multiple reflectors.

The present disclosure may be adaptable to a variety of different platforms and launchers. It should be noted that the systems and methods of deployment of the present disclosure may be used to deploy reflectors described in U.S. patent application Ser. No. 63/654,320.

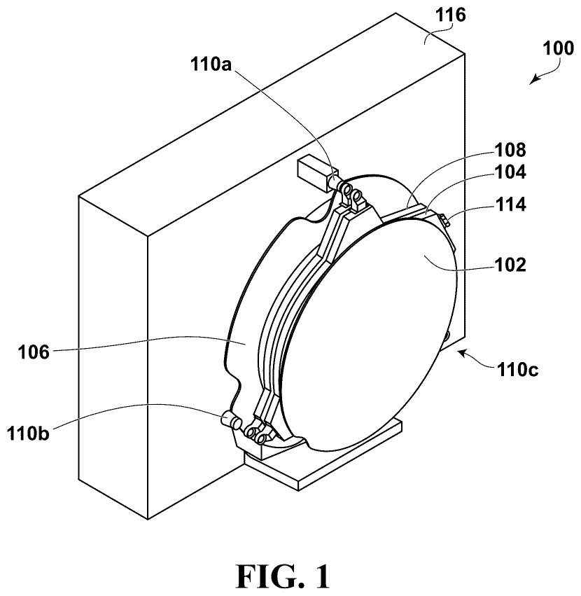

Referring now to FIG. 1, shown therein is a perspective view of a foldable reflector pallet 100 in a folded or stowed configuration, according to an embodiment.

In FIG. 1, the foldable reflector pallet 100 is shown with a first reflector shell 102 facing outward (i.e., its RF reflective surface is facing outward). In the foldable reflector pallet 100, the first reflector shell 102 may be facing inward. It will be appreciated that the foldable reflector pallet 100 may be mounted to or otherwise disposed on a spacecraft according to either configuration.

The foldable reflector pallet 100 includes the first reflector shell 102 and a second reflector shell 106 (collectively referred to as the reflector shells 102, 106). In FIG. 1, the second reflector shell 106 faces towards a spacecraft platform 116, and the first reflector shell 102 faces away from the spacecraft platform 116. The reflector shells 102, 106 may be made of or may include carbon-fiber-reinforced-polymer (CFRP) or aluminum.

The reflector shells 102, 106 may each be a solid-shell reflector. Solid-shell reflectors present numerous advantages over mesh reflectors, such as lower cost, efficient reflection in certain frequency bands (e.g., the Ka band), non-parabolic shaping, and less to no undesirable passive intermodulation (PIM). The single-piece nature of typical solid-shell reflectors ordinarily means that there is no way to effectively stow such solid-shell reflectors to minimize the launch stay-in volume thereof without folding or otherwise disassembling the individual reflectors. The reflector shells 102, 106 of the present disclosure may advantageously be stowed to minimize the launch stay-in volume, as will be further explained hereinbelow. The foldable reflector pallet 100 may advantageously allow or provide for a more compact stowed configuration to permit the use of larger antenna geometries on small satellite platforms.

A first backing 104 is disposed adjacent the first reflector shell 102, which together constitute a first reflector. A second backing 108 is disposed adjacent the second reflector shell 106, which together constitute a second reflector. The backings 104, 108 provide a support structure for the reflector shells 102, 106 and are shaped to provide rigidity and strength to the reflector assembly while providing a mechanical interface to the connectors 110a, 110b, and 110c as further discussed hereinbelow. The first backing 104 and the second backing 108 are linked by a connection 114 that permits folding of the first backing 104 relative to the second backing 108 and vice-versa (i.e., permits folding of the first reflector shell 102 relative to the second reflector shell 106 and vice-versa to fold the foldable pallet 100). The connection 114 may be referred to as inter-reflector connection 114 or inter-reflector connector 114.

The backings 104, 108 may be formed of a thick panel and a thin ring bonded to the reflector shells 102, 106, respectively. The backings 104, 108 may be formed of a grid of thin panels.

The foldable pallet 100 is mounted or otherwise disposed on a spacecraft platform 116. The spacecraft platform 116 may be a satellite. The spacecraft platform 116 may be a spacecraft, a space station, or a vehicle (such as a space shuttle or a rover).

The foldable pallet 100 is mounted or otherwise disposed on the spacecraft via connectors 110a, 110b, and 110c (collectively referred to as the connectors 110 and generically referred to as the connector 110). A different number of connectors 110 (e.g., 4) may be used. The backings 104, 108 and/or the reflector shells 102, 106 may be relatively thick and may have the connectors 110 disposed directly thereon. The connectors may be referred to as or considered “hold and release mechanisms” (HRM) or “hold down and release mechanisms” (HDRM) or “tie-down mechanisms”. The connectors 110 are configured to maintain a reliable and solid connection between the spacecraft platform 116 and the reflector shells 102, 106 and the backings 104, 108 during launch. Upon activation or actuation of the connectors 110, the connectors 110 release the first reflector and the second reflector in orbit for deployment thereof.

Although the foldable reflector pallet 100 is shown as including two reflector shells 102, 106, it will be appreciated that a reflector 100 with more than two such reflector shells is included in the scope of the present disclosure. The reflector 100 may have any number of such shells suitable for high-capacity antennas or multi-aperture antennas.

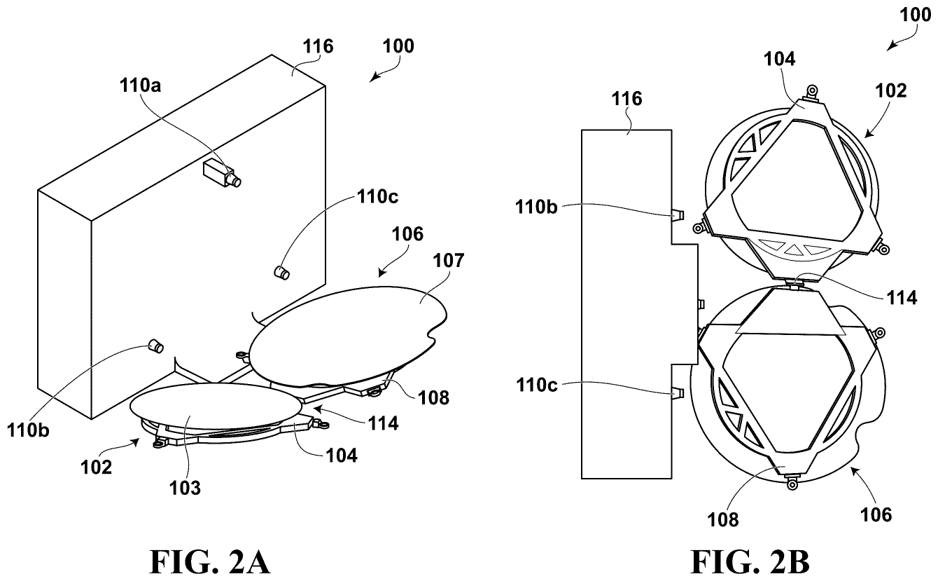

Referring now to FIGS. 2A and 2B, shown therein are perspective and bottom views, respectively, of the foldable reflector pallet 100 in an unfolded or deployed configuration, according to an embodiment. In FIGS. 2A and 2B, identical numerals denote identical references with respect to FIG. 1.

In FIGS. 2A and 2B, it may be more clearly seen that the first and second reflector shells 102, 106 include respective reflective surfaces 103, 107 disposed opposite the respective first and second backings 104, 108.

In the unfolded and deployed configuration, the reflector shells 102, 106 are positioned to reflect incoming and outcoming signals. The specific signals or band of signals reflected or able to be reflected may depend upon the particular size, shaping, curvature (e.g., convex or concave, local and/or global curvature), angle, and/or material of each of the reflector shells 102, 106.

The reflector shells 102, 106 may be identical.

The reflector shells 102, 106 may be different in one or more respects (e.g., made of different materials, shaped or curved differently (locally or globally)). In other words, the reflector shells 102, 106 may have the same physical properties or differ in one or more physical properties.

The first backing 104 and the second backing 108 are joined at the connection 114 to facilitate folding or stowing the foldable reflector pallet 100 in the configuration shown in FIG. 1.

The connection 114 may be a hinge. The hinge may be a passive hinge (e.g., a spring and damper) including a latch to lock the unfolded configuration. The hinge may be an active hinge (e.g., a rotary actuator such as a stepper motor coupled to a gearbox) to allow for repointing of the deployed reflector pallet 100. The connection 114 may further include telemetry for position feedback and a temperature sensor. The connection 114 may further include heaters installed thereon to ensure a minimum operating temperature for unfolding and operation. The connection 114 is configured to reliably and accurately unfold or cause unfolding of the pallet 100 from the folded configuration to a mission position (i.e., the deployed and unfolded configuration).

The foldable reflector pallet 100, and in particular the connection 114, advantageously provide a stiffer configuration to the reflectors, as the backings 104, 108 are connected together at the center of the pallet 100 when folded, thus reducing the distance to the centre of gravity and further increasing the rigidity of the assembly, i.e., of the foldable reflector pallet 100.

The connection 114, especially in the embodiment where the connection 114 is a hinge, may advantageously be used to correct any misalignment between the two reflectors (and may further be used for trimming or reconfiguration in orbit).

In a preferred embodiment, the foldable reflector pallet 100 includes the backings 104, 108 as shown in FIGS. 1, 2A, and 2B. However, in other embodiments, the foldable reflector pallet 100 may not include the backing 104 and/or the backing 108.

In FIG. 1, the foldable pallet 100 is shown in the folded configuration such that the reflective surface 103 faces away from the spacecraft platform 116, the reflective surface 107 faces towards the spacecraft platform, and the reflector 106 is disposed between the spacecraft platform 116 and the reflector 102. It will be appreciated by one of skill in the art that the reflective surfaces 103, 107 may face towards or away from the spacecraft platform 116 (both reflective surfaces 103, 107 together facing towards or away, or one such reflective surface facing towards and the other facing away) and that the reflectors 102, 106 may be disposed in any order relative to the spacecraft platform 116.

For greater certainty, it is explicitly contemplated herein that the reflectors 102, 106 may be provided with or without the backings 104, 108, that the reflective surfaces 103, 107 may be facing towards or away from the spacecraft platform 116 (in the same or opposite orientations), and that the reflector 106 may be disposed between the spacecraft platform 116 and the reflector 102 or that the reflector 102 may be disposed between the spacecraft platform 116 and the reflector 106. All permutations and combinations of the foregoing conditions are expressly contemplated herein.

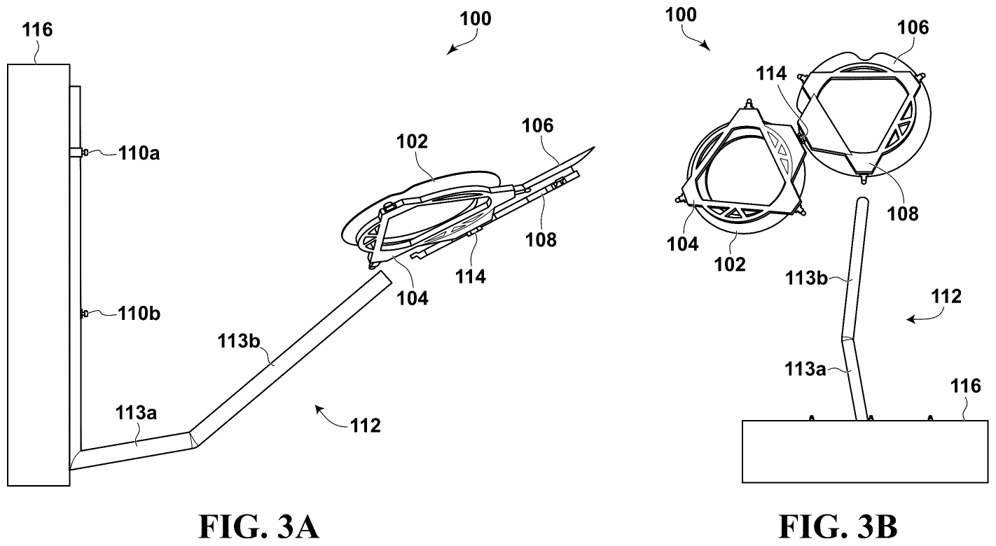

Referring now to FIGS. 3A and 3B, shown therein are a perspective side view and a bottom view, respectively, of the foldable reflector pallet 100 in an unfolded and deployed configuration, according to an embodiment. In FIGS. 3A and 3B, identical numerals denote identical references with respect to FIG. 1.

In FIGS. 3A and 3B, a boom 112 connects the foldable reflector pallet 100 to the spacecraft 116 or to any other surface or object to which the foldable reflector pallet 100 is mounted or on which the foldable reflector pallet 100 is disposed. The boom 112 may orient as well as deploy the foldable reflector pallet 100, i.e., the boom may rotate the foldable reflector pallet 100 along one or more degrees of freedom. The boom 112 deploys the foldable reflector pallet to the deployment configuration, i.e., to the mission position.

The boom 112 comprises a plurality of segments 113a, 113b (collectively referred to as the boom segments 113 and generically referred to as the boom segment 113). Although only two boom segments 113a, 113b are shown in FIGS. 3A, 3B, it will be appreciated that the boom 112 may comprise any number of boom segments 113 suitable for deploying the foldable reflector pallet 100, i.e., for actuating the foldable reflector pallet 100 from the folded or stowed configuration of FIG. 1 to the unfolded or deployed configuration of FIGS. 2A, 2B as further shown in FIGS. 3A, 3B.

In an embodiment, the boom 112 comprises a single boom segment 113.

The boom segments 113 may be connected by hinges, joints, or any other fasteners.

Advantageously, the foldable reflector pallet 100 allows for only a single boom 112 to be provided (e.g., as opposed to two booms for deploying the two reflectors).

The reflector pallet 100 may be particularly suited to small spacecraft launched using small rockets or rideshare missions. The reflector pallet 100 may be applicable to geostationary equatorial orbit (GEO) and non-geostationary orbit (NGSO) antennas. In GEO, a satellite circles the Earth at the same rate as Earth's own rotation, appearing fixed or stationary in the sky. In NGSO, a satellite circles the Earth at a lower altitude than GEO and completes an orbit in a shorter period of time, not appearing fixed or stationary in the sky. Unlike geostationary satellites, which are located at a specific point in the sky relative to the Earth's surface, NGSO satellites are constantly moving across the sky. This may provide several advantages over geostationary satellites, such as the ability to provide better coverage for mobile satellite services, improve global connectivity, and offer more efficient use of the limited radio frequency spectrum. That the reflector pallet 100 is suitable for both GEO and NGSO antennas is highly advantageous. The reflector pallet 100 may further be utilized in other orbits, including but not limited to polar orbits, sun-synchronous orbits, medium Earth orbits, and/or highly elliptical orbits. The reflector pallet 100 may further be utilized in extra-planetary or deep-space applications.

The foldable reflector pallet according to the present disclosure advantageously uses fewer moving parts or components in general in order to deploy a plurality of reflectors. For example, as discussed with respect to FIGS. 3A-3B, a single boom 112 may be provided for the foldable reflector pallet 100 that includes the shells 102, 106 and the backings 104, 108 (i.e., the first and second reflectors) rather than two booms.

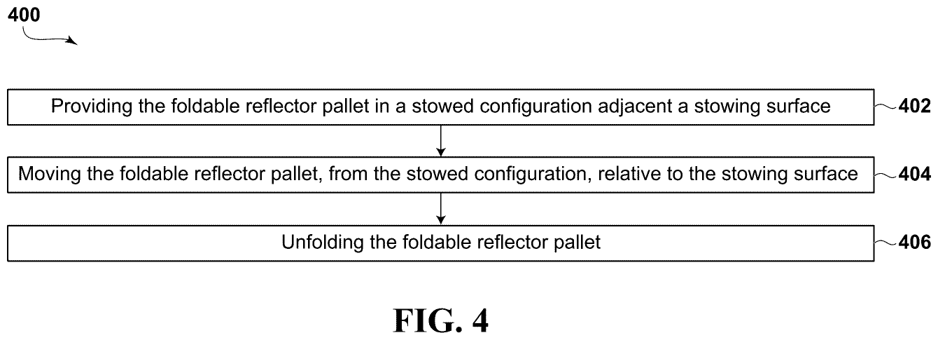

Referring now to FIG. 4, shown therein is a flow diagram of a method 400 for deploying and unfolding a foldable pallet reflector relative to a stowing surface, according to an embodiment. The foldable pallet reflector may be the foldable pallet reflector 100 of FIGS. 1-3C. The stowing surface may be the spacecraft 116 of FIGS. 1-3C.

At 402, the method 400 includes providing the foldable reflector pallet in a stowed configuration adjacent to the stowing surface (e.g., as shown in FIG. 1). The reflector pallet includes first and second reflectors. The first and second reflectors each have a backing structure. The backing structures of the of the first and second reflectors are hingedly connected but otherwise physically separate sections. The hinged connection may include one or more hinges.

At 404, the method 400 further includes moving the foldable reflector pallet, from the stowed configuration, relative to the stowing surface. Moving may be achieved via an active deployment (e.g., via an actuator) or a passive deployment.

The foldable reflector pallet may be actuated via a boom connected to the foldable reflector pallet and the stowing surface (e.g., as shown in FIG. 3A or 3B via the boom 112). The boom may be a multi-hinge boom. In other embodiments, the foldable reflector pallet may be actuated by another type of actuator or manipulator. The actuator may be a standard one or two axis gimbal.

At 406, the method 400 further includes unfolding the foldable reflector pallet (e.g., as shown in FIG. 2A or 2B) using the hinged connection between the backing structures of the first and second reflectors.

It will be appreciated by one of skill in the art that the foldable reflector pallet may be unfolded partially or completely before, during, or after the foldable reflector pallet is actuated relative to the stowing surface.

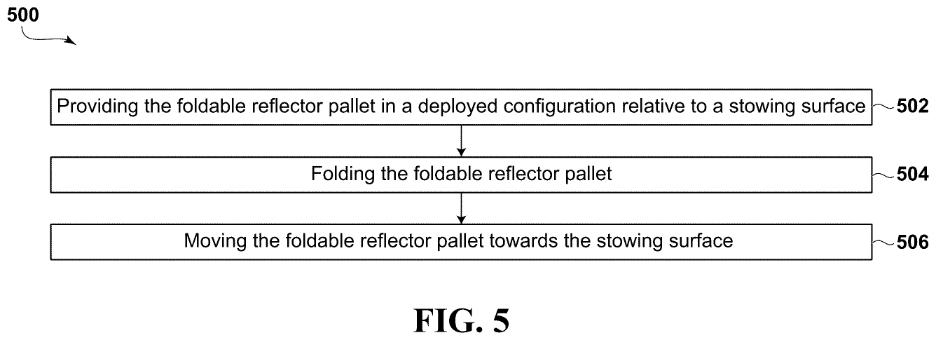

Referring now to FIG. 5, shown therein is a flow diagram of a method 500 for stowing and folding a foldable reflector pallet relative to a stowing surface, according to an embodiment. The foldable pallet reflector may be the foldable pallet reflector 100 of FIGS. 1-3C. The stowing surface may be the spacecraft 116 of FIGS. 1-3C.

At 502, the method 500 includes providing the foldable reflector pallet in a deployed configuration relative to the stowing surface (e.g., as shown in FIG. 3A or 3B). The reflector pallet includes first and second reflectors. The first and second reflectors each have a backing structure. The backing structures of the of the first and second reflectors are hingedly connected but otherwise physically separate sections. The hinged connection may include one or more hinges.

At 504, the method 500 further includes folding the foldable reflector pallet (e.g., as shown in FIG. 1) using the hinged connection between the backing structures of the first and second reflectors.

At 506, the method 500 further includes moving the foldable reflector pallet towards the stowing surface. The boom may be a multi-hinge boom. Moving may be achieved via an active deployment (e.g., via an actuator) or a passive deployment. In other embodiments, the foldable reflector pallet may be actuated by another type of actuator or manipulator. The actuator may be a standard gimbal.

The foldable reflector pallet may be actuated via a boom connected to the foldable reflector pallet and the stowing surface (e.g., as shown in FIG. 3A or 3B via the boom 112).

It will be appreciated by one of skill in the art that the foldable reflector pallet may be folded partially or completely before, during, or after the foldable reflector pallet is actuated towards the stowing surface.

While the above description provides examples of one or more apparatus, methods, or systems, it will be appreciated that other apparatus, methods, or systems may be within the scope of the claims as interpreted by one of skill in the art.

1. A foldable reflector pallet for reflecting a radio frequency (RF) signal, the foldable reflector pallet having a smaller footprint when stowed than when deployed, the foldable reflector pallet comprising:
first and second reflectors each comprising a respective reflective surface, for reflecting the RF signal in a deployed configuration, the first and second reflectors mutually attached by a permanent connector;
at least one temporary connector mounted to a stowing surface for detachably connecting to the first and/or second reflector in a stowed configuration;
wherein the first and second reflectors are configured to selectively move between the deployed configuration, in which the first and second reflectors are not folded about the permanent connector, and the stowed configuration, in which the first and second reflectors are folded about the permanent connector.

2. The foldable reflector pallet of claim 1, further comprising a boom or gimbal for moving the first and second reflectors away from the stowing surface in the deployed configuration.

3. The foldable reflector pallet of claim 2, wherein the boom or gimbal comprises a plurality of segments.

4. The foldable reflector pallet of claim 1, wherein the at least one temporary connector includes three temporary connectors.

5. The foldable reflector pallet of claim 1, wherein the stowing surface is a spacecraft or a portion of a spacecraft.

6. The foldable reflector pallet of claim 2, wherein the boom or gimbal for moving the first and second reflectors away from the stowing surface is the only boom or gimbal respectively provided in the foldable reflector pallet.

7. The foldable reflector pallet of claim 1, wherein each reflector is disposed opposite a respective backing.

8. A method of deploying a foldable reflector pallet for reflecting a radiofrequency (RF) signal, the foldable reflector pallet having a smaller footprint when stowed than when deployed, the method comprising:
providing the foldable reflector pallet in a stowed configuration adjacent a stowing surface;
actuating the foldable reflector pallet, from the stowed configuration, relative to the stowing surface; and
unfolding the foldable reflector pallet.

9. The method of claim 8, wherein actuating the foldable reflector pallet relative to the stowing surface comprises actuating the foldable reflector pallet via a boom or gimbal away from the stowing surface.

10. The method of claim 8, wherein the boom or gimbal comprises a plurality of segments.

11. The method of claim 9, wherein the boom or gimbal is the only boom or gimbal, respectively provided in the foldable reflector pallet.

12. A method of stowing a foldable reflector pallet for reflecting a radiofrequency (RF) signal, the foldable reflector pallet having a smaller footprint when stowed than when deployed, the method comprising:
providing the foldable reflector pallet in a deployed configuration relative to a stowing surface;
folding the foldable reflector pallet; and
actuating the foldable reflector pallet towards the stowing surface.

13. The method of claim 12, wherein actuating the foldable reflector pallet towards the stowing surface comprises actuating the foldable reflector pallet via a boom or gimbal towards the stowing surface.

14. The method of claim 13, wherein the boom or gimbal comprises a plurality of segments.

15. The method of claim 13, wherein the boom or gimbal is the only boom or gimbal respectively provided in the foldable reflector pallet.
